(19) United States
(12) Patent Application Publication
(10) Pub. No.: US 2013/0156395 A1
(43) Pub. Date: Jun. 20, 2013

(54) DIGITAL VIDEO AUDIO PLAYER RECORDER DEVICE

(71) Applicant: Pradeep Ramdeo, Bronx, NY (US)

(72) Inventor: Pradeep Ramdeo, Bronx, NY (US)

(21) Appl. No.: 13/327,791

(22) Filed: Dec. 16, 2011

(51) Int. Cl. H04N 5/77

(52) U.S. Cl. 386/224; 386/E05.07

(57) ABSTRACT

A video audio player recorder device which includes a housing. A hard drive is built-in the housing. A wireless receiver is built in the housing and is electrically connected to the hard drive. The wireless receiver can receive media information from a Wi-Fi network and a built-in data streaming software allows downloading the media information to the hard drive for storage. The built-in data streaming software allows the hard drive to play back the media information to a remote television set or computer.

### BACKGROUND OF THE INVENTION

1. Field of the Invention

The present invention relates to a digital video recorder, and more particularly, a digital video audio player recorder device.

Many individuals enjoy watching movies and listening to music. Currently, a media collection of a person is often in the form of CDs and DVDs. These discs tend to consume valuable space in the home and can even become misplaced throughout the years. They are also prone to damage can be rendered useless. Some discs can only be viewed in a specific type of player. A more efficient option is needed.

The digital video audio player recorder device will assist a person in managing, viewing, and storing, their favorite movies, videos, photos and music. The present invention affords the person access to their media library at all times without the need of a computer. The person is able to store their entire media collection on the device and is even able to record television shows and movies for playback. The device eliminates the need to purchase and store CDs, DVDs, and other forms of media information. The present invention uses a storage component, such as a hard drive, to save a large variety of media information that can be accessed at any time.

2. Description of the Prior Art

Numerous innovations for video recording systems have been provided in the prior art that will be described. Even though these innovations may be suitable for the specific individual purposes to which they address, however, they differ from the present invention.

A FIRST EXAMPLE, U.S. Patent Office Publication No. 2007/0172212, Published on Jul. 26, 2007, to Miyagawa teaches when a preprogrammed recording is set, a recording medium to be used for the preprogrammed recording is specified using an identifier. In a case where the recording medium with the specified identifier is not attached to the drive unit when a content is to be recorded, the content is recorded onto a relief recording medium. If the recording medium with the specified identifier is attached to the drive unit after the content has already been recorded onto the relief recording medium, the content is dubbed onto the recording medium with the specified identifier.

A SECOND EXAMPLE, U.S. Patent Office Publication No. 2009/0129758, Published on May 21, 2009, to Fuji teaches a video recording device which includes: a first identification block that reads video information from a first recording medium in which video information on an analog television broadcast is stored, and identifies the broadcasting format of the read video information; a recording execution block that records the video information, which is read from the first recording medium, in a second recording medium other than the first recording medium; a second identification block that when the video information is recorded in the second recording medium by the recording execution block, identifies the broadcasting format of the video information to be recorded in the second recording medium; and a format decision block that decides whether the broadcasting format identified by the second identification block agrees with the broadcasting format identified by the first identification block. When the format decision block decides that the broadcasting formats do not agree with each other, the recording execution part records the video information in the second recording medium according to the broadcasting format identified by the first identification block.

A THIRD EXAMPLE, U.S. Patent Office Publication No. 2009/0136215, Published on May 28, 2009, to Barton et al. teaches a digital video recorder (DVR) system with an integrated DVD recording device accepts TV input streams in a multitude of forms. Analog TV streams are converted to an MPEG formatted stream for internal transfer and manipulation, while pre-formatted MPEG streams are extracted from the digital TV signal and presented in a similar format. Indexes within the MPEG stream are determined and saved at predefined intervals and are stored on a hard disk along with the MPEG program material and used to create navigation packets when writing to a DVD inserted in an integrated DVD player/recorder. When a program is requested for display from the hard disk or the integrated DVD player/recorder, the program material are extracted from the appropriate source and reassembled into an MPEG stream which is sent to a decoder. The decoder converts the MPEG stream into TV output signals and delivers the TV output signals to a TV monitor. User control commands are accepted which affect the flow of the MPEG stream allowing the user to view stored programs with special functions: reverse, fast forward, play, pause, index, fast/slow reverse play, and fast/slow play. The user can select program material stored on the hard disk to be written to a DVD and can also select program material stored on a DVD to be transferred to the hard disk.

A FOURTH EXAMPLE, U.S. Patent Office Publication No. 2009/0320073, Published on Dec. 24, 2009, to Reisman teaches systems and methods for navigating hypermedia using multiple coordinated input/output device sets. Disclosed systems and methods allow a user and/or an author to control what resources are presented on which device sets (whether they are integrated or not), and provide for coordinating browsing activities to enable such a user interface to be employed across multiple independent systems. Disclosed systems and methods also support new and enriched aspects and applications of hypermedia browsing and related business activities.

A FIFTH EXAMPLE, U.S. Patent Office Publication No. 2010/0118194, Published on May 13, 2010, to Kimura teaches according to one embodiment, a video display device that has a connection unit configured to connect to a plurality of external instruments via a network, a receiving unit configured to receive, from the plurality of external instrument connected to the video display device via the connection unit, standard compatibility information indicating that the external instrument meets the mutual controllability standards, a display unit configured to display video information output by one of the plurality of external instruments and a selection unit configured to select one of the plurality of external instruments, corresponded to information based on the standard compatibility information, connected to the connection unit as an output source of video information to be displayed on the display unit.

It is apparent now that numerous innovations for video recording systems have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a video audio player recorder device that avoids the disadvantages of the prior art.

ANOTHER OBJECT of the present invention is to provide a video audio player recorder device that is simple and inexpensive to manufacture.

STILL ANOTHER OBJECT of the present invention is to provide a video audio player recorder device that is simple to use.

BRIEFLY STATED, STILL YET ANOTHER OBJECT of the present invention is to provide a video audio player recorder device which comprises a housing. A hard drive is built in the housing. A wireless receiver is built in the housing and is electrically connected to the hard drive. The wireless receiver can receive media information from a Wi-Fi network and download the media information to the hard drive for storage. The hard drive can play back the media information to a remote television set or computer.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a block diagram showing the various components of the present invention;

FIG. 2 is a perspective view of the present invention; and

FIG. 3 is a perspective view showing the present invention in use.

### REFERENCE NUMERALS UTILIZED IN THE DRAWING

110 video audio player recorder device
112 housing of device 110
114 hard drive of device 110
116 wireless receiver of device 110
118 Wi-Fi network
120 television set
122 computer
123 person
124 CD/DVD player/burner of device 110
126 digital camera of device 110
128 USB port of device 110
130 home cable system
132 SD port of device 110
134 internet
136 remote control unit of device 110

### DETAILED DESCRIPTION OF THE PREFERRED EMBODIMENT

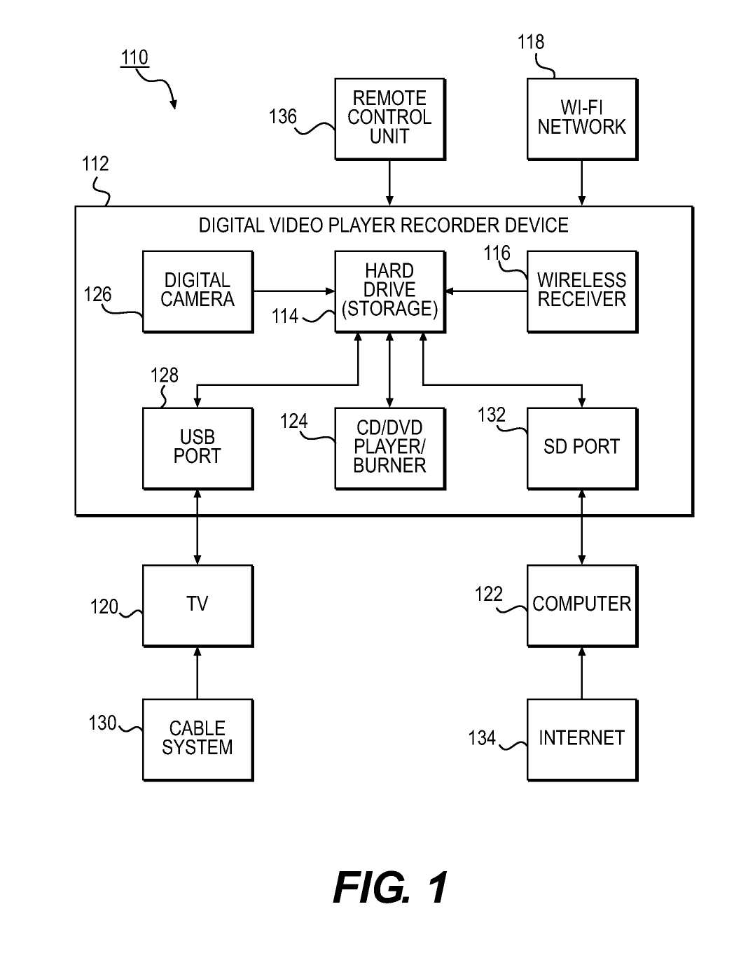

As shown in FIG. 1, the present invention is a video audio player recorder device 110 which comprises a housing 112. A hard drive 114 is built in the housing 112. A wireless receiver 116 is built in the housing 112 and is electrically connected to the hard drive 114. The wireless receiver 116 can receive media information from a Wi-Fi network 118 and a built-in data streaming software allows downloading the media information from the Internet to the hard drive 114 for storage. The built-in data streaming software also allows the hard drive 114 to play back the media information to a remote television set 120 or a computer 122 for a person 123. The device 110 can be about 6 inches (width)×12 inches (length)×1.5 inches (thickness) in sizes.

A CD/DVD player/burner 124 is built-in the housing 112 and electrically connected to the hard drive 114, whereby music and movies can be directly loaded onto the hard drive 114. A digital camera 126 is built-in the housing 112 and is electrically connected to the hard drive 114, whereby the digital camera 126 can send pictures directly to the hard drive 114.

A USB port 128 built in the housing 112 and is electrically connected to the hard drive 114. The television set 120 connected to a home cable system 130 can be wired to the USB port 128 to send media information directly to the hard drive 114. A SD port 132 is built in the housing 112 and is electrically connected to the hard drive 114. The computer 122 connected to the internet 134 can be wired to the SB port 132 to send media information directly to the hard drive 114. The device 110 further comprises a remote control unit 136 to operate the device 110. The device uses 110 Volt power source.

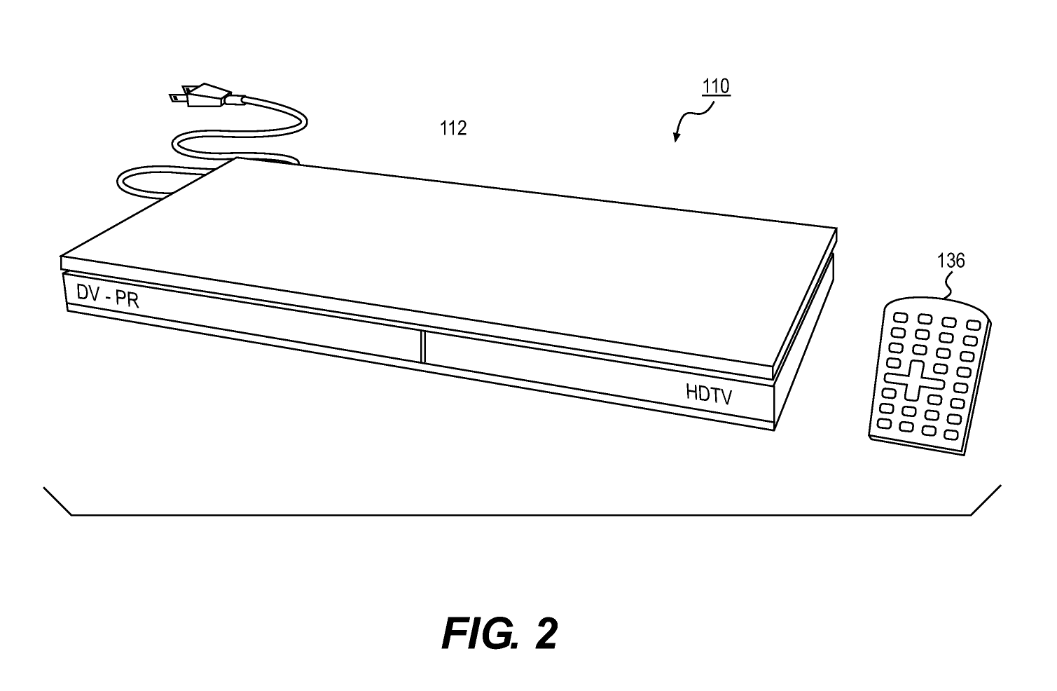

FIG. 2 shows a perspective view of the video audio player recorder device 110 and the remote control unit 136.

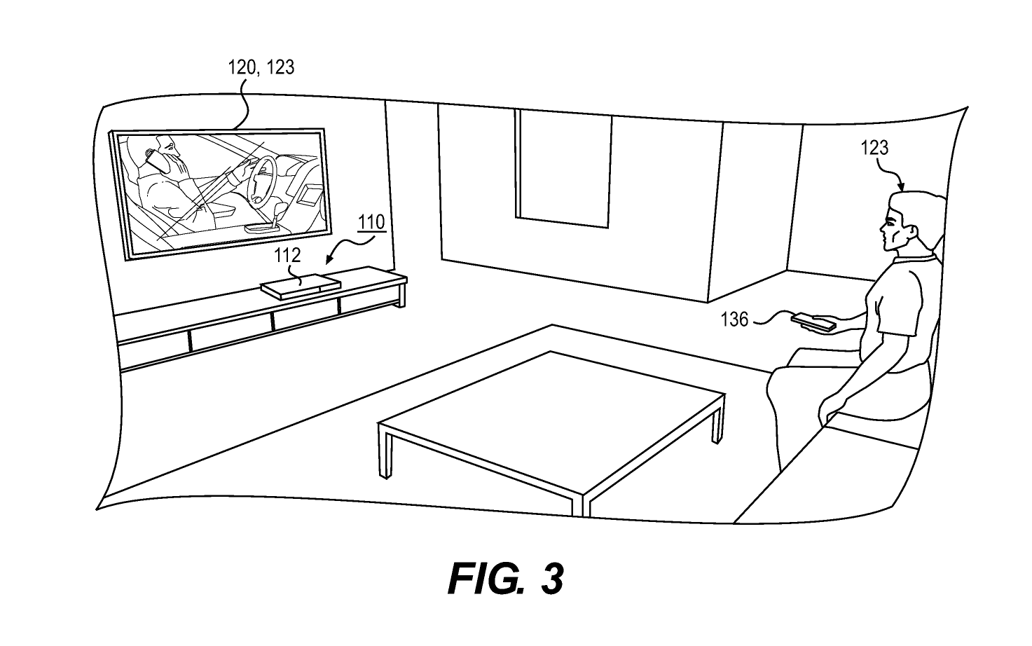

FIG. 3 shows a perspective view of the person 123 utilizing the remote control unit 136 to operate the remote television set 120.

In review, the video audio player recorder device 110 provides a person 123 with an efficient way of organizing and viewing their media library. The present invention is an electronic apparatus that is available in various models (different shapes and sizes). It can be connected directly to a remote television set 120 or computer 122 if desired. The device 110 functions similar to a digital video recorder. It has the ability to download from the internet 134 or record media information at a set time and date from the home cable system 130. The device 110 includes a housing 112 with a built in hard drive 114 to receive media information from a Wi-Fi network 118. Movies, music, and shows may be purchased from a website or other forum and downloaded directly to the built in hard drive 114 using the Wi-Fi network 118. The Wi-Fi network 118 can be a mobile virtual private network is used for roaming seamlessly across networks and in and out of wireless-coverage areas without losing application sessions or dropping the secure VPN session. A conventional VPN cannot survive such events because the network tunnel is disrupted, causing applications to disconnect, time out, or fail, or even cause the computing device itself to crash. Instead of logically tying the endpoint of the network tunnel to the physical IP address, each tunnel is bound to a permanently associated IP address at the device 110. The mobile VPN software handles the necessary network authentication and maintains the network sessions in a manner transparent to the application and the user.

The device 110 also includes a USB port 128, SD port 132, the ability to download and play internet games, a digital camera 126, a wireless receiver 116, and the ability to run applications. The device 110 can also be operated by using a remote control unit 136. It also includes a CD/DVD player/burner 124, so that movies and music may be loaded onto the hard drive 114. The device 110 allows the person 123 to organize their media information in a variety of ways, such as by category, genre, or by favorites. The device 110 is able to be used in all rooms of the house. This allows the person 123 to access their media information from anywhere in the home. The exact specifications may vary.

It will be understood that each of the elements described above, or two or more together, may also find a useful application in other types of constructions differing from the types described above.

While the invention has been illustrated and described as embodiments of a video audio player recorder device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A video audio player recorder device which comprises:
a) a housing;
b) a hard drive built in the housing; and
c) a wireless receiver built in the housing and electrically connected to the hard drive, the wireless receiver can receive media information from a Wi-Fi network and
d) a built-in data streaming software allows downloading the media information from the Internet to the hard drive for storage, whereby the built-in data streaming software can play back the media information to a remote television set or computer.

2. The device as recited in claim 1, further comprising a CD/DVD player/burner built in the housing and electrically connected to the hard drive, whereby music and movies can be directly loaded onto the hard drive.

3. The device as recited in claim 2, further comprising a digital camera built in the housing and electrically connected to the hard drive, whereby the digital camera can send pictures directly to the hard drive.

4. The device as recited in claim 3, further comprising a USB port built in the housing and electrically connected to the hard drive, whereby the television set connected to a home cable system can be wired to the USB port to send media information directly to the hard drive.

5. The device as recited in claim 4, further comprising a SD port built in the housing and electrically connected to the hard drive, whereby the computer connected to the internet can be wired to the SB port to send media information directly to the hard drive.

6. The device as recited in claim 5, further comprising a remote control unit to operate the device.

7. The device as recited in claim 1, wherein the Wi-Fi network can be a Virtual Private Network.

8. The device as recited in claim 1, wherein the device uses 110 Volt power source.

9. The device as recited in claim 1, wherein the device can be about 6 inches (width)×12 inches (length)×1.5 inches (thickness) in sizes.
